(19) United States
(12) Patent Application Publication
(10) Pub. No.: US 2005/0284416 A1
(43) Pub. Date: Dec. 29, 2005

(54) Dog Cooling Garment

(75) Inventors: Julie A. Smit, Evanston, IL (US); Nadine S. Oleksy, Niles, IL (US)

Correspondence Address: Julie A.Smit, 1045 Hinman Ave., Evanston, IL, 60202, US

(73) Assignees: Ms. Julie A. Smit, Evanston, IL (US); Ms. Nadine S. Oleksy, Niles, IL (US)

(21) Appl. No.: 10/710,239

(22) Filed: Jun. 28, 2004

(51) Int. Cl. A01K 13/00

(52) U.S. Cl. 119/850

(57) ABSTRACT

A cooling garment for dogs to aid in the prevention of heatstroke during hot weather walks. The cooling garment containing a bladder for water, whereby, the cooling garment may be easily stored and frozen in the freezer prior to use. The underside of the cooling garment containing a means to adhere to the dog's coat so the cooling garment stays situated on the back and sides of the dog during warm weather walks and exercise. A sun reflective surface may, additionally, be utilized to further aid in cooling the animal.

### BACKGROUND OF INVENTION

This invention relates to cooling devices and more particularly to cooling devices for dogs.

Heatstroke is a leading cause of death for dogs. This is because dogs do not have sweat glands to cool their body temperature. Additionally, many breeds have profuse coats, which exacerbates the possibility of heatstroke.

Heatstroke is an emergency condition, which needs medical attention as soon as possible, otherwise the dog will die.

According to New Choices in Natural Healing for Dogs & Cats by the Editors of “Prevention Magazine”, once heatstroke occurs the dog must be cooled immediately in a tub of cool water or by applying ice packs to the dog's body. This must be done even before the vet is called, otherwise the dog may die.

Today with the increasing popularity of condominiums and town homes, many dogs have little or no yards to exercise in and for relieving themselves. Walking an elderly, debilitated, or long-furred dog on a hot, sunny day becomes extremely dangerous for such a susceptible dog.

Up to now, there has been no preventative measure for heatstroke during hot weather walks other than by wetting your pet with water prior to their walk or by adapting a human ice pack to their body. Pet shops have no products on the store shelves to aid in the prevention of heatstroke during hot weather walks. Such being the case, pet owners must come up with their own solutions to cool their dogs in dangerously, hot weather or run the risk of death/fatigue.

The usual way is wetting the dog with cool water, which is drippy and messy. Besides this, the dog's first inclination is to shake the water off, thereby, splattering it all over the person.

Furthermore, when the drenched dog walks in dirt, the dog becomes extremely muddy and later tracks up the inside of the house. Even if one goes through the mess of drenching the dog, the dog doesn't stay cool for any length of time on a hot weather walk.

Another way of trying to prevent heatstroke during warm weather walks is trying to adapt a human cooling pack, however, a human cooling pack is not designed to fit a dog's body nor to adhere to a dog's coat. For example, a human cooling pack will constantly slide off the slick fur of the animal, as there is nothing on it to grip the dog's coat.

Also, a human cooling pack can be dangerous for a dog because it is usually filled with a toxic substance in order to retain the cold longer. The toxic substance will quickly poison the dog that accidentally rips open and swallows the toxic substance.

Additionally, a human cooling pack doesn't reflect the extra heat, from the dog, caused from the bright sun beating down on the animal.

Also, for reasons of practicality, a dog cooling garment must be easy to clean, and mildew resistant so that it may be quickly and easily re-frozen between hot weather walks.

Accordingly, it is an object of this invention to design an ice pack for dogs, which prevents heatstroke from occurring during hot weather walks.

It is a further object of this invention to make a cooling garment, which properly fits the contours of a dog's body.

It is a further object to design a cooling device, which doesn't slide off the dog's coat.

Still another object is to make a cooling device, which is totally non-toxic in case the dog rips it open and swallows the fluid.

Yet another object is to utilize a sun reflective surface to aid in cooling the animal.

Still another object is to utilize waterproof, mildew resistant materials so that it may be quickly and easily re-frozen without the need to air dry the garment.

### SUMMARY OF INVENTION

In keeping with an aspect of the invention, the dog cooling garment is made out of a water resistant material such as vinyl. The dog cooling garment contains a bladder with a series of tanks or reservoirs filled with water or other non-toxic substance. One side of the dog cooling garment has a reflective surface and the other side has a rubberized backing, which adheres by friction to the dog's coat. The rubberized backing prevents the cooling garment from sliding off the back of the animal due to its comparatively top-heavy nature. A vinyl strap, which goes around the stomach of the animal, further holds the cooling garment secure on the back and sides of the dog.

In operation, the dog cooling garment is filled with water, placed in a freezer bag for reasons of sanitation, and stored in the freezer. When a hot weather walk is necessary, the owner places the cooling garment over the back and sides of the dog. The rubberized back adheres by friction to the fur to prevent slippage and further insulates the dog from the frozen pack. The cooling garment is intended for use only over furry areas of the animal. The coolness may be too intense on bare skin areas. In operation, the dog will stay cool and safe for at least a 30-minute walk in the heat. Afterwards, the vinyl cooling garment is wiped off and placed back in the freezer bag for easy storage in the freezer. The cooling garment is made of vinyl or other non-porous material so that there is no need to air dry it between walks and freezer storage in order to prevent mildew.

### BRIEF DESCRIPTION OF DRAWINGS

The preferred embodiments of the invention may become more apparent from the following specification, taken with the attached drawings, wherein:

FIG. 1 is a diagram of a dog wearing the cooling garment;

FIG. 2 schematically shows the dog cooling garment outstretched;

FIG. 3 is a cross-section of a side view of the dog cooling garment showing the rubberized backing;

FIG. 4 shows the underside of the dog cooling garment with an alternate means for gripping the dog's coat to prevent slippage;

FIG. 5 shows a side view of another alternate means for gripping the dog's coat to prevent slippage; and

FIG. 6 shows an alternate cooling garment wherein the bladder is permanently sealed with water eliminating the need to refill it.

### DETAILED DESCRIPTION

FIG. 1 shows a dog wearing the dog cooling garment 10. Dog cooling garment 10 contains a bladder 12 for holding water or other non-toxic substance. An empty/fill opening 14 allows access to the inside of bladder 12 so that it may be filled with water prior to being frozen. Dog cooling garment 10 is proportioned to fit over the back and sides of the dog. Dog cooling garment 10 is intended to be used only over the furry areas of the animal, such as back and sides, otherwise, the cold may be too intense. Dog cooling garment 10 may be manufactured in a variety of sizes to fit the diverse sizes of dogs, such as toy, small, medium, and large. A vinyl strap 16 positioned across the abdomen of the animal holds the garment in position.

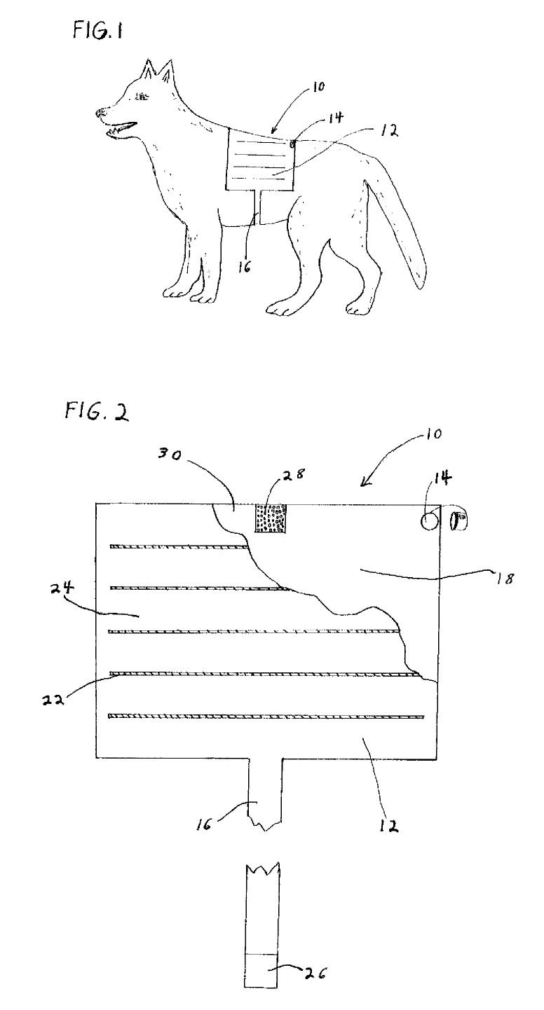

FIG. 2 shows dog cooling garment 10 outstretched as if looking down on the exterior 18. Dog cooling garment 10 is made up of a series of reservoirs 20 which are positioned horizontally and parallel to the back of the animal. Reservoirs 20 are made from a series of walls 22, which are formed by bonding the two sides of bladder 12 together. Walls 22 allow dog cooling garment 10 to bend in the areas of walls 22, thereby, adjusting to the contours of the dog's body. A continuous passageway 24 exists between reservoirs 20 and empty/fill opening 14 so that the entire bladder 12 may be easily filled or emptied of water. Velcro tab 26 on vinyl strap 16 may be mated to Velcro tab 28 on the dog cooling garment 10 to secure the garment in position on the back and sides of the dog. Buckles, snaps, clasps and the like could also be utilized for the attachment instead of Velcro. Exterior 18 may be made of a reflective material 30 to better cool the dog from the hot sun.

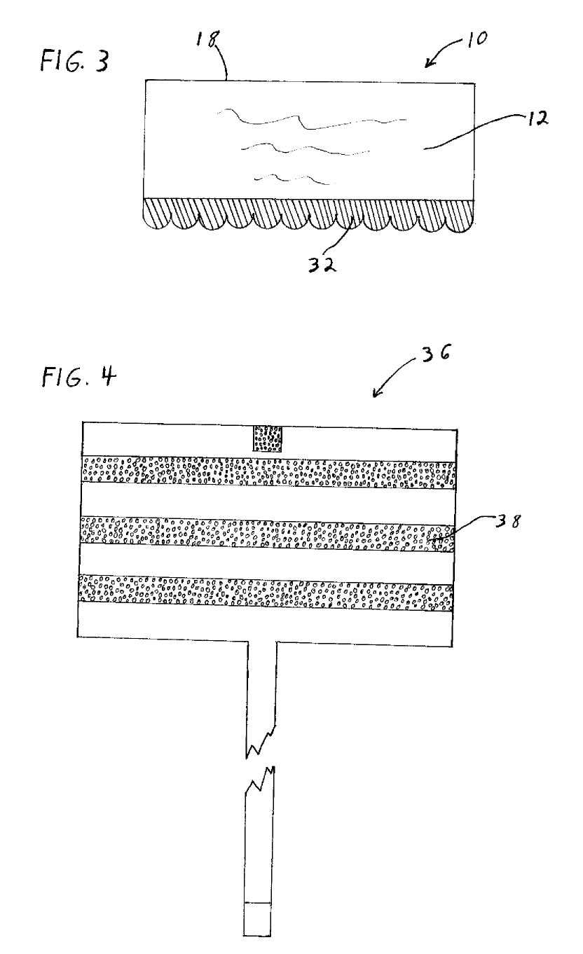

FIG. 3 is a cross section of a side view of the dog cooling garment 10. Here a rubberized material 32 is bonded to the underside of dog cooling garment 10. The purpose of the rubberized material 32 is to catch by friction the dog's coat to hold the cooling garment 10 on the back and sides of the dog. This feature is especially necessary for an active dog, which is either walking of exercising. Without a means to catch the dog's fur, the dog cooling garment will slide over to one side and then around to the stomach of the animal due to its comparatively top heavy nature.

FIG. 4 shows an alternate dog cooling garment 36. Here bands or strips of Velcro 38 are secured to the underside of the cooling garment 36. In greater detail, there are two mates to the Velcro bond. It is found that the looped side of Velcro grips a dogs fur and can be utilized to help stabilize the cooling garment on the back and sides of the animal.

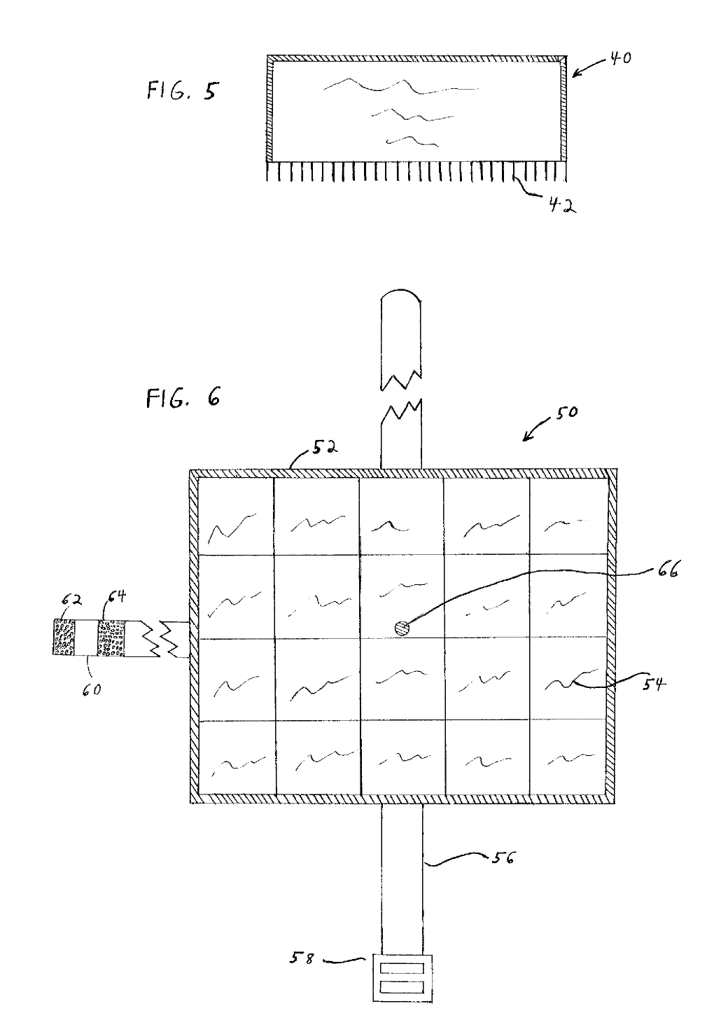

FIG. 5 shows by side view still another alternate dog cooling garment 40. In this embodiment dog cooling garment 40 contains a brush-type means 42 on the underside of the garment. The brush-type means 42 gripes the fur to prevent slippage of cooling garment 40 during warm weather walks and exercise.

FIG. 6 shows an alternate dog cooling garment 50. Here the bladder 52 is permanently filled with water 54, thus, eliminating the need to refill bladder 52. Vinyl strap 56 contains a buckle 58 for adjustment around the abdomen of the animal. Any of the means for gripping the dog's coat may be utilized with the alternative cooling garment 50. A collar strap 60 may, also, be utilized with cooling garment 50 and looped around the collar of the dog to add further stability. Mated Velcro stripes 62 and 64 can secure the collar strap around the collar. A temperature indicator element 66 may, also, be utilized to change color to visually notify the owner as to when the cooling garment is no longer cool. It should now be apparent how the invention works. In operation, the cooling garment is placed in a freezer bag and stored in the freezer. When the dog is going for a walk in the heat, the cooling garment is placed on the furry back and sides of the dog so the dog may be safe and cool during its walk. The vinyl cooling garment adheres to the coat of the animal with the various fur gripping means disclosed herein. A reflective surface may be utilized to further aid in cooling the dog from the hot sun. All the features disclosed herein may be easily substituted and combined with each other. Also, those skilled in the art will perceive still other minor changes to the invention. Therefore, the appended claims are to be construed broadly enough to cover all equivalent structures falling within the scope and spirit of this invention.

1. A cooling garment for animals to aid in the prevention of heatstroke during warm weather walks and exercise, whereby, said cooling garment contains a bladder for storing a non-toxic substance, said cooling garment being placed in a refrigerated device to cool said cooling garment prior to said warm weather walk or exercise session, the underside of said cooling garment containing a means for adhering to an animal's coat of fur, said cooling garment being made of a non-porous, mildew-resistant material so there is no need to air dry it between warm weather use and storage in said refrigerated device, said cooling garment containing alternating areas of reservoir tanks and areas in which said bladder is bonded together, whereby, said areas which are bonded together being capable of bending to adjust to the contours of the animal's back and sides, strap means around abdomen to further secure said cooling garment on the back and sides of the animal.

2. The cooling garment of claim 1 wherein the exterior of said cooling garment is a reflective surface to repel sunlight.

3. The cooling garment of claim 1 wherein the bladder of said cooling garment contains an empty/fill opening, wherein, said cooling garment might be filled or emptied of water.

4. The cooling garment of claim 1 wherein the fluid containing bladder of said cooling garment being permanently sealed to eliminate the need to refill and empty said bladder.

5. The cooling garment of claim 1 wherein said means for gripping an animal's coat of fur comprises a rubberized material which adheres by friction to the animals coat.

6. The cooling garment of claim 1 wherein said means for gripping an animal's coat of fur comprises areas of Velcro.

7. The cooling garment of claim 1 wherein said means for gripping an animal's coat of fur comprises a brush or comb type means on the underside of said cooling garment.

8. The cooling garment of claim 1 wherein said cooling garment contains a neck or collar strap to further secure said cooling garment on the back of the animal.

9. The cooling garment of claim 1 wherein said cooling garment contains a temperature indicator to visually aid the dog walker as to when said cooling garment is no longer cool.

10. A cooling garment for animals to aid in the prevention of heatstroke during warm weather walks, whereby, said cooling garment contains a bladder for storing a non-toxic substance, said cooling garment being placed in a refrigerated device to cool said cooling garment prior to said warm weather walk, the exterior of said cooling garment containing a reflective surface to repel the sunlight from the cooling garment to further aid in cooling the animal, said cooling garment being made of a non-porous, mildew-resistant material so there is no need to air dry it between warm weather walks and storage in said refrigerated device, said cooling garment containing alternating areas of reservoir tanks and areas in which said bladder is bonded together, whereby, said areas which are bonded together being capable of bending to adjust to the contours of the animal's back and sides, strap means around abdomen to further secure said cooling garment on the back and sides of the animal.

11. The process of preventing heatstroke in animals during warm weather walks and exercise, said process comprising the steps of: placing a cooling garment containing reservoirs which contain a non-toxic material into a refrigerated device to cool or freeze the fluid-filled reservoirs; placing said cooling garment over the furry back of sides of the animal; the underside of said cooling garment containing a means to grip the animal's coat of fur to prevent the comparatively top heavy cooling garment from sliding off the back of the animal due to the top heavy nature of said fluid-filled reservoirs; walking the animal in the heat and, thereby, preventing heatstroke because of the cooling nature of said cooling garment; removing said cooling garment from the animal and placing it back into said refrigerated device to chill or re-freeze said fluid-filled reservoirs; and no need to air dry said cooling garment prior to re-freezing because said cooling garment is a non-porous, mildew resistant material.
